(19) United States
(12) Patent Application Publication
(10) Pub. No.: US 2010/0154263 A1
(43) Pub. Date: Jun. 24, 2010

(54) Hunter Safety Apparatus

(76) Inventor: Eddie Dwayne Riverio, Oviedo, FL (US)

Correspondence Address: THE PATENT GUILD, 313 COURTNEY SPRINGS CIRCLE, WINTER SPRINGS, FL, 32708, US

(21) Appl. No.: 12/641,267

(22) Filed: Dec. 17, 2009

Related U.S. Application Data
(60) Provisional application No. 61/138,883, filed on Dec. 18, 2008.

(51) Int. Cl. G09F 13/16

(52) U.S. Cl. 40/582

(57) ABSTRACT

A Hunter Safety Apparatus which includes a Marking Ribbon and a Safety Signage System. The Hunter Safety Signage System includes a Safety Sign and a place to store reflective pins which are used by the hunters to find their way through a hunting area. Hunters stick the reflective pins to trees and branches as they walk through the hunting area to mark their path. The Marking Ribbon is generally a rectangular length of flexible reflective material which is attachable to tree and other support indicate present or future hunting use of a location.

This application relates to provisional application No. 61/138,883 filed Dec. 18, 2008.

### FIELD OF THE INVENTION

The Hunter Safety Apparatus relates to hunter safety methods and techniques which allow hunters to let other hunters or hikers know that hunters are hunting in an area or planning to hunt in a specific area thereby making it safer for all.

### BACKGROUND OF THE INVENTION

A number of methods and devices currently exist which are useful for marking trails, including the general use of reflective signs, reflective tape, and reflective tacks. More advanced methods include the use of electronically enhanced systems which illuminate paths and signs. Often these devices provide either a hodge-podge collection of items which are difficult to carry, can prick or poke a user carrying the items, or are an expensive bulky device which requires bringing along a power source such as batteries. What is needed is an apparatus which combines the reflective surface area of a sign (and is suitable for indicia) with a safe, convenient method for carrying reflective tacks or pins in an inexpensive easy to handle device which does not require a power source.

### SUMMARY OF THE INVENTION

The Hunter Safety Apparatus includes a Marking Ribbon and a Safety Signage System. The Hunter Safety Signage System includes a Safety Sign and a place to store reflective pins which are used by the hunters to find their way through the hunting area. Hunters stick the reflective pins to trees and branches as they walk through the hunting area to mark their path. The Hunter Safety Sign easily attaches trees and branches to indicate a hunt is in progress within the area of the Hunter Safety Sign. If needed, a reflective pin can be used to attach the Hunter Safety Sign to a tree or branch or the hunter can wear the sign in an appropriate location. The Marking Ribbon is generally a rectangular length of flexible reflective material which is attachable to tree and other support indicate present or future hunting use of a location.

An advantage of the Hunter Safety Apparatus' Marking Ribbon is that hunters can mark a spot they wish to hunt in the future (such as the preseason) by placing a Marking Ribbon in the area they plan to hunt. This will let others know that they plan on hunting there and therefore keep others from hunting, attempting to hunt, or planning to hunt in the same spot, thereby making the hunt safer and more enjoyable for all.

### BRIEF DESCRIPTION OF THE DRAWINGS

FIG. 1 presents a front view of the Marking Ribbon.

FIG. 2 presents a side view of the Hunter Safety Sign.

FIG. 3 presents a rear view of the Hunter Safety Sign.

FIG. 4 presents a front view of the Hunter Safety Sign.

FIG. 5 presents the Hunter Safety Sign attached to a tree.

FIG. 6 presents the Marking Ribbon attached to a tree.

FIG. 7 presents the Hunter Safety Sign attached to a tree.

FIG. 8 presents the Hunter Safety Sign attached to a tree.

FIG. 9 presents a rear view of the Hunter Safety Sign.

FIG. 10 presents a rear and front view of a pair of Hunter Safety Signs.

### DRAWINGS—REFERENCE NUMERALS

1—Safety Sign base plate

2—Safety Sign mounting clip

3—Safety Sign pin mounting strip

4—Safety Sign reflective pins

5—Marking Ribbon

6—Marking Ribbon eyelet

7—Marking Ribbon reflective strip

8—Safety Sign mounting aperture

9—Safety Sign reflective surface

10—Safety Sign indicia

11—Marking Ribbon indicia

12—Safety Sign mounting post

13—Tree

### DETAILED DESCRIPTION

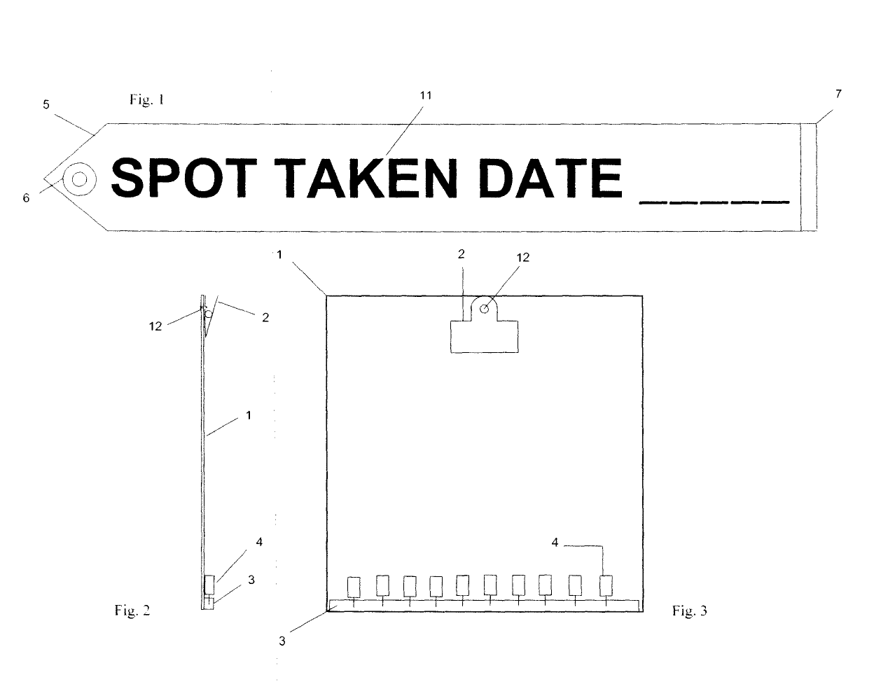

The Hunter Safety Apparatus Marking Ribbon, as shown in FIG. 1 and FIG. 6, is generally rectangular length of flexible material which includes at least one ribbon eyelet 6 at a first end and at least one reflective strip 7 at an opposite end. Informational indicia 11 is provided on at least one side of the ribbon. It is envisioned that additional eyelets 6, additional reflective strips 7, additional informational indicia 11 can be positioned on the Marking Ribbon 5 as needed, and the Marking Ribbon 5 may be non-rectangular in shape. Further, it is envisioned the Marking Ribbon 5 material may be plastic, paper, foil, wood, or other known signage material including biodegradable material and environmentally friendly material. Additionally, it is envisioned the Marking Ribbon 5 may be of any desired color, including multiple colors and may include any desired pattern, such as a camouflage patter which suits the surrounding environment.

The hunter safety Marking Ribbon 5 can be pinned or clipped to a tree or branch or can slide onto a branch thru the eyelet 6. The Marking Ribbon 5 can also be tied to a tree or branch by using string or rope (not shown). This will let others know that you plan to hunt the area surrounding the Marking Ribbon 5. A phrase or informational indicia 11 can be provided on the Marking Ribbon 5 and which include a preprinted message (such as “SPOT TAKEN ” and an area for hunters or users to write-in any desired information such as the hunters initials, a hunting license number, a reserved hunting date, or any other message. The Marking Ribbon 5 includes a reflective strip 7 made of reflective type material (such as reflective tape or a reflective coating), positioned at an end of the Marking Ribbon 5. This will allows hunters and hikers to see Marking Ribbon 5 in the dark or low light by using a flashlight.

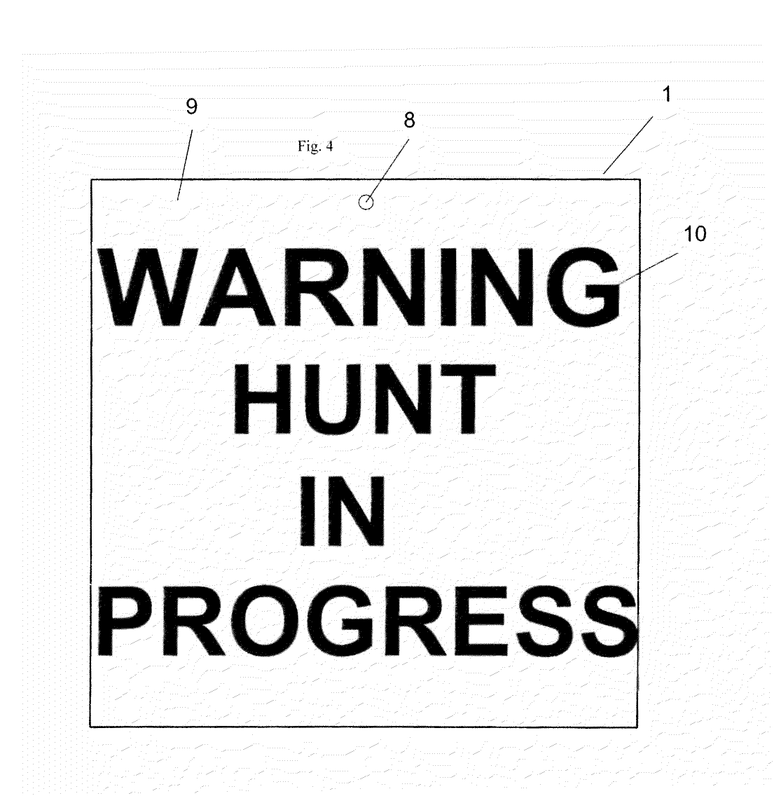

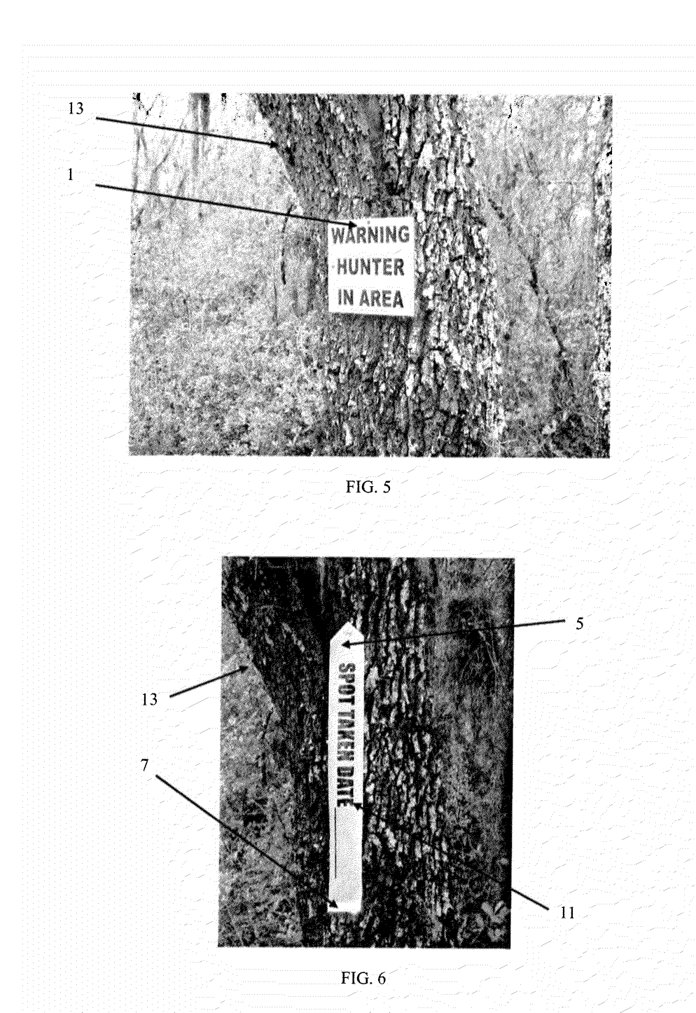

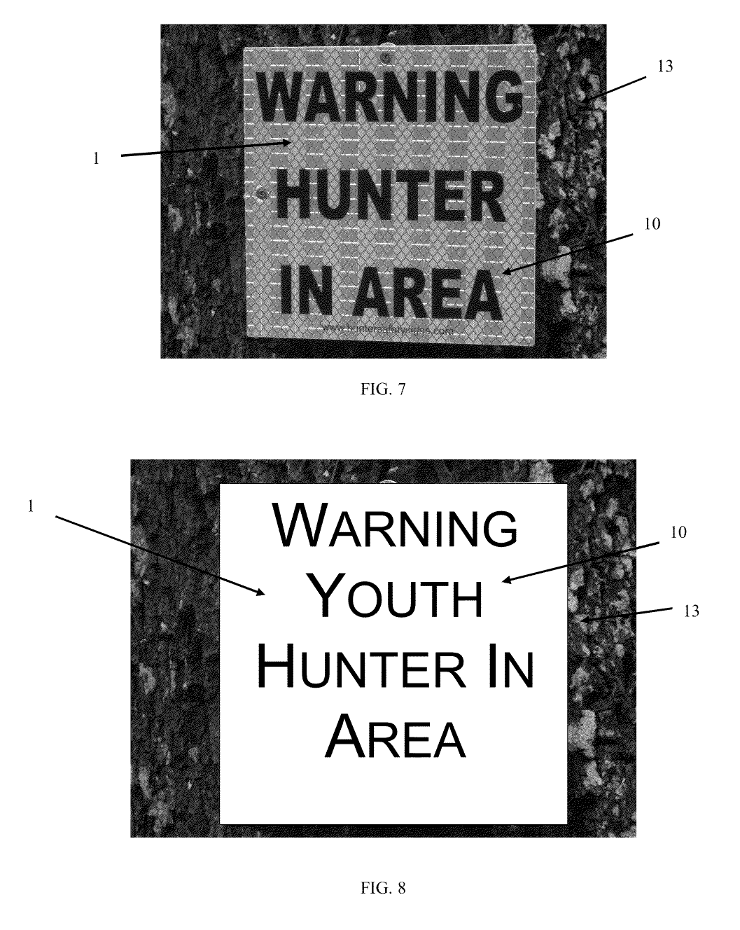

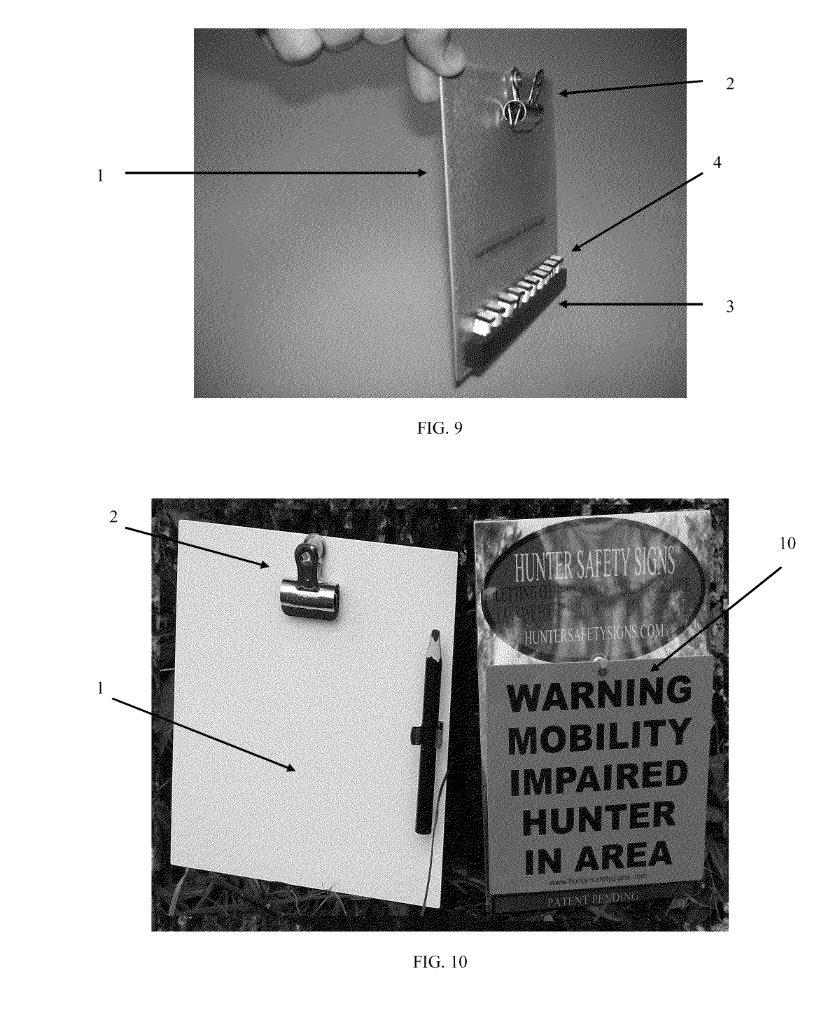

The Hunter Safety Apparatus Safety Signage System, as shown in FIGS. 2-5, 7 and 8-10 includes a base plate 1, a sign mounting clip 2, a pin mounting strip 3, reflective pins 4, a mounting aperture 8, a reflective surface 9 on the front or back of the base plate 1, and indicia 10 (such as “WARNING HUNTER IN AREA”, “WARNING YOUTH HUNTER IN AREA”, or “WARNING MOBILITY IMPAIRED HUNTER IN AREA”, or other indicia) on the front or back of the base plate 1. The pin mounting strip 3 is positioned on the rear of the base plate 1, generally at a low location on the rear of the base plate 1. The pin mounting strip 3 is attached using generally known permanent or semi-permanent attachment methods including, using an adhesive or magnets.

The reflective pins 4 are inserted into the pin mounting strip 3 and removed and used to mark a hunting or path location or to mount the base plate 1 to a tree, bush or other item. Reflective pins 4 are generally available reflective pins 4 and included reflective material on at least one surface. Each reflective pin 4 includes an extension which is inserted into the pin mounting strip 3 when the reflective pin 4 is secured to the base plate 1.

At least one sign mounting clip 2 is provided on the front or rear of the base plate 1. Preferably, a sign mounting clip 2 is provided on the rear of the base plate 1 at an end opposite from the pin mounting strip 3.

The base plate 1 may include a mounting aperture 8 and a mounting post 12 for securing the sign mounting clip 2 to the base plate 1.

The mounting aperture 8 may be a circular hole or an irregular slot (not shown) so that the sign mounting clip 2 can be easily repositioned on the base plate 1 as need.

The pin mounting strip 3 may also be positioned near the edge of the base plate 1 and the reflective pins 4 can mounted on the pin mounting strip 3 with reflective side portions of the reflective pins 4 extending beyond the edge of the base plate 1 thereby allowing the reflective pins 4 to pins reflect light and indicate the location of the base plate 1 even when viewed from the front of the base plate 1. This is particularly useful if the hunter is wearing the base plate 1 such as by clipping the base plate to his clothing.

It is envisioned that alternated methods of mounting the base plate to a desired location may be provided, such as using string, wire, cloth, or other generally known mounting components. The components of the above Hunter Safety Apparatus Safety Signage System may be made smaller or larger in as size as need for the particular usage.

It is further envisioned the indicia 10 will vary depending on the information to be conveyed.

Further, it is understood the Hunter Safety Apparatus Safety Signage System may be used in a variety of non-hunting environments (such as sigh-seeing, general camping, and emergency response situation—such as fire evacuations) where there is a need to notify others of the presence of a Hunter Safety Apparatus Safety Signage System user, or to notify others of the intention of Hunter Safety Apparatus Safety Signage System user to use a selected area, or to mark the path/trail of a Hunter Safety Apparatus Safety Signage System user. It is envisioned that the Hunter Safety Apparatus Safety Signage System may be provided as separate components.

In use, the Hunter Safety Apparatus Safety Signage System operates by the user, he/she enters the selected hunting area, attaching the base plate 1 to a tree, a branch or a portable item such as a back pack (not shown) or portable tree stand to indicate the selected hunting area so that other hunters or hikers will know the hunter is hunting in the designated area.

As the hunter hunts, he/she deploys the reflective pins 4 to mark the path traveled. The pin mounting strip 3 which was semi-permanently attached can be removed from the base plate 1 entirely and used to hold the reflective pins 4 as the hunter deploys the reflective pins 4 by pushing them into trees and or branches to mark his/her hunting trail/path. Otherwise, the hunter can selectively remove as many reflective pins 4 from the pin mounting strip 3 as needed prior to traveling the hunting path and deploy the reflective pins 4 as desired.

The hunting path/trail marked by the reflective pins assist the hunter in finding his/her way out in the dark because the reflective pins 4 will reflect light from a flashlight. Also the reflective pins 4 let others know that the path taken by the hunter and can aid in helping rescuers find lost hunters. When the hunter returns to the starting area, the pins are re-inserted into the pin mounting strip 3.

Additionally, elements and components of the instant invention may be made of any appropriately suitable material including but not limited to foam, rubber, rubberized foam, wood, plastic, metal, high strength composites and fibers, fiberglass, as appropriate.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A hunter safety sign comprising:
a base plate,
a sign mounting clip positioned near an edge of the base plate,
a pin mounting strip positioned near an edge of the base plate,
reflective pins removably positioned on the pin mounting strip,
a mounting aperture positioned near an edge of the base plate,
a reflective surface on the front or back of the base plate, and
indicia displayed on the front or back.

2. The hunter safety sign of claim 1 wherein the sign mounting clip and the pin mounting strip are positioned near opposite edges of the base plate.

3. The hunter safety sign of claim 2 wherein the indicia is displayed on the front of the base plate and both the sign mounting clip and the pin mounting strip are positioned on the rear of the base plate.

4. The hunter safety sign of claim 1 further including a reflective surface on the front or back of the base plate.

5. The hunter safety sign of claim 3 further including a reflective surface on the front or back of the base plate.

6. A hunter safety apparatus comprising:
a base plate,
a sign mounting clip positioned near an edge of the base plate,
a pin mounting strip positioned near an edge of the base plate,
reflective pins removably positioned on the pin mounting strip,
a mounting aperture positioned near an edge of the base plate,
a reflective surface on the front or back of the base plate,
indicia displayed on the front or back, and
a marking ribbon.

7. The hunter safety apparatus of claim 6 wherein the marking ribbon is generally a rectangular length of flexible material which includes at least one ribbon eyelet at a first end and at least one reflective strip at an opposite end.

8. The hunter safety apparatus of claim 7 wherein a reflective surface and indicia is provided on the front of the base plate and both the sign mounting clip and the pin mounting strip are positioned on the rear of the base plate.
